(19) United States
(12) Patent Application Publication
(10) Pub. No.: US 2009/0179434 A1
(43) Pub. Date: Jul. 16, 2009

(54) Gas power augmented wind generator

(76) Inventor: Steven Cornelius, Taft, TN (US)

Correspondence Address: STEVEN L. CORNELIUS, 9 BLANCHE CIRCLE, TAFT, TN, 38488, US

(21) Appl. No.: 12/008,175

(22) Filed: Jan. 10, 2008

(51) Int. Cl. F01D 15/10; F03D 9/00

(52) U.S. Cl. 290/4 R; 290/55

(57) ABSTRACT

Compressed natural gas (CNG) fueled auxiliary power source in the 100-250 brake horsepower range, mounted (hung) on the rear of the wind generator main shaft, equipped with shaft speed sensors that have been calibrated to minimum/maximum desired main shaft (electrical generator) speed and that can engage and spin the main shaft attached to the electrical power generator on demand when there is insufficient wind to do so.

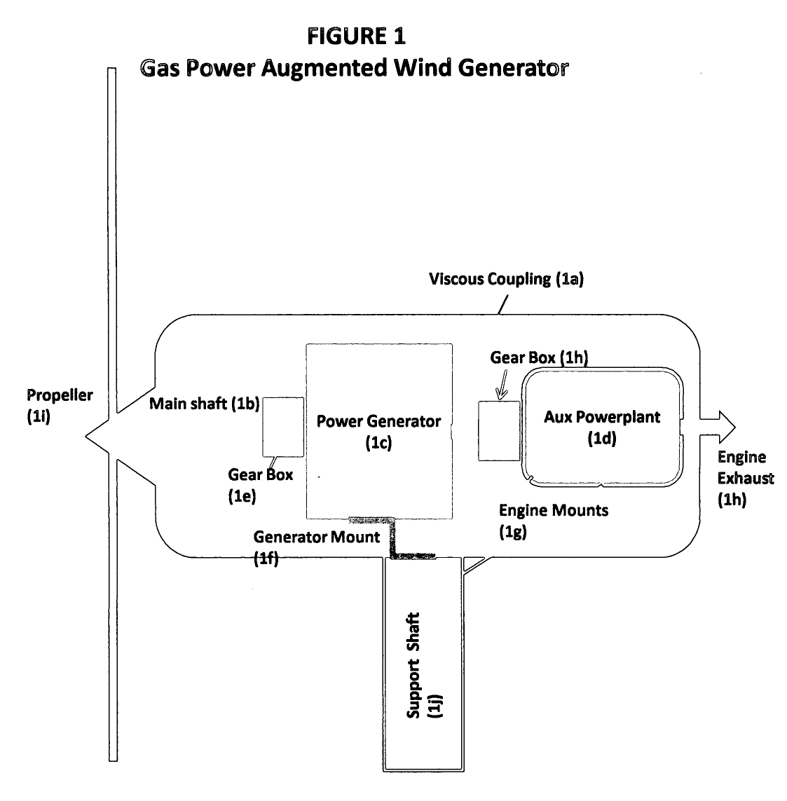

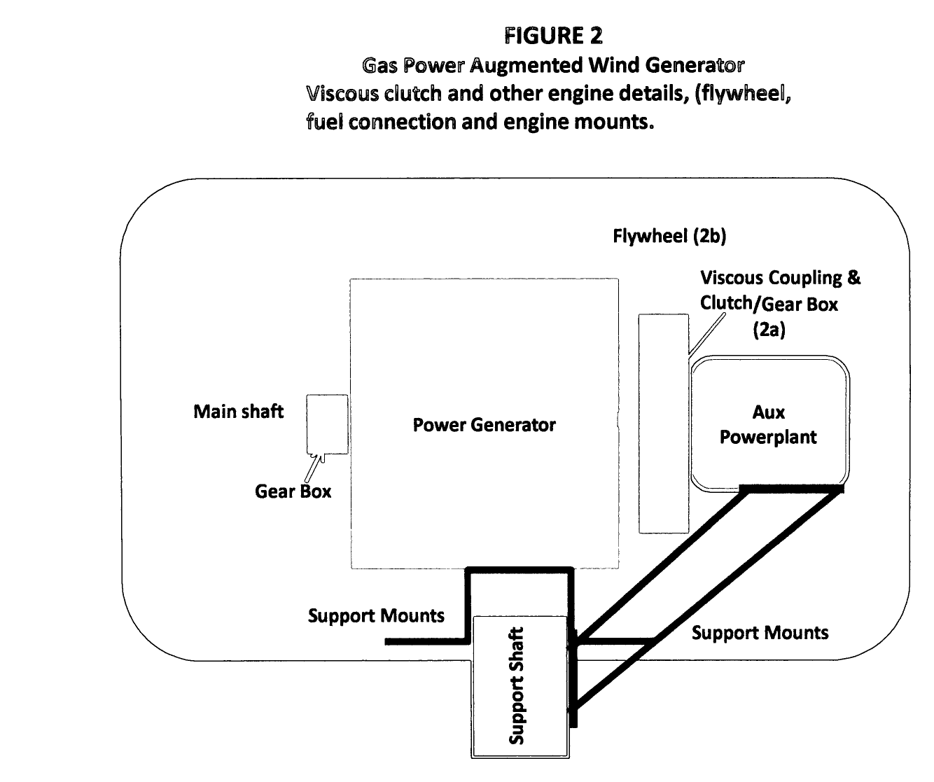

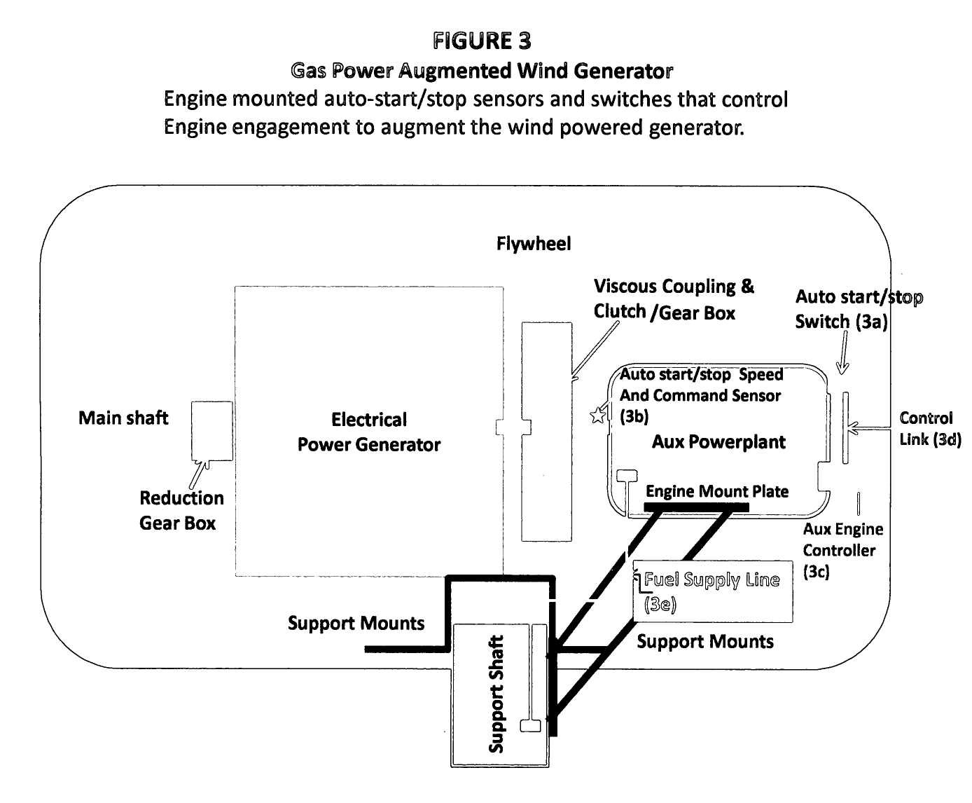

A compressed natural gas (CNG) fueled auxiliary power source for wind powered electrical generators. The output range for the engine (FIG. 1d, page 14) will range between 100-250 horsepower and when equipped with all necessary sensors, monitors and switches configured for this application (FIGS. 3a through 3d, page 16) and installed on the auxiliary unit to sense when there is insufficient wind (based upon main shaft revolutions per minute—RPM) to turn the main shaft and generate electricity, will provide sustaining power to maintain minim RPM necessary to generate electricity at the desired output level. The auxiliary/dual power unit will weigh less than 1000 pounds. The auxiliary engine will be joined to the main turbine shaft of the wind powered electrical generator via a viscous planetary (reduction gear) system (FIG. 2a, page 15) commonly used in automotive applications. The planetary gearing system and a viscous coupling system, very much like the power distribution system on a full-time all-wheel drive set-up employed on some sports utility vehicles, allows the auxiliary engine to engage and maintain generator shaft speed when needed and disengage when wind velocity is sufficient to turn the generator shaft. This approach will save fuel and engine wear when the auxiliary power supply isn't needed to turn the main shaft and generate a constant supply of electricity.

### CROSS-REFERENCE TO RELATED APPLICATION

None

### STATEMENT REGARDING FEDERALLY SPONSORED RESEARCH OR DEVELOPMENT

No Federal research or development funds were used in the development of this concept/product.

### REFERENCE TO SEQUENCE LISTING, A TABLE OR A COMPUTER PROGRAM LISTING COMPACT DISC APPENDIX

None

### BACKGROUND OF THE INVENTION

Currently, wind powered electrical generators are completely dependent upon a sufficient velocity of wind blowing over their massive propellers, rotating the main throughput shaft which is connected to an electrical generator, spinning the generator which in turn produces electricity for consumer use. The uncertainty of achieving consistent wind velocity and direction has been the historical and primary limiting factor preventing large-scale adaption of wind power to augment the national electrical grid.

I believe the answer to the wind power problem is to mount a small, efficient natural gas engine to the back end of the wind-power generation unit. The auxiliary CNG engine would automatically engage and turn the electrical generator shaft when shaft revolutions per minute (RPM) drop below the generator manufacturer's recommended speed range (minimum speed necessary to generate rated electrical output). The most likely condition requiring auxiliary power will be when wind velocity is insufficient or gusting (unpredictable) and unable to constantly turn the main generator shaft at the required RPM for specified electrical output.

The auxiliary engine would use the latest automotive technology to provide “on demand” power augmentation to maintain shaft RPM in the optimal electricity generating range. If the generator shaft RPM drops below the lowest acceptable RPM for power generation (250 RPM, for example), a sensor mounted on the generator main shaft (FIG. 3b, page 16) will send an electrical signal, triggering the CNG powered aux engine. The aux engine will use auto-start technology (FIGS. 3a through 3d, page 16) that are currently employed in hybrid electric-gasoline automobiles to instantly start-up and cut-off, as well as activate and deactivate cylinders for optimum economy of operation.

This patent submission represents my proposed solution to this national problem.

### BRIEF SUMMARY OF THE INVENTION

A 100-250 horsepower, aluminum and cast iron natural gas powered engine equipped with auto start/stop switching mounted on the rear of the wind-power generation unit (under the unit weather fairing) that is coupled to the main turbine shaft (FIG. 1b, page 14) of the wind powered electrical generator. The engine is connected to the main power generator throughput shaft via a viscous coupling (FIG. 2a, page 15) or clutch (borrowed from full-time all wheel drive vehicles) that allows power to be applied to the main generator shaft as needed and also to freewheel without placing drag or resistance on the main shaft when the aux engine isn't needed. A natural gas (CNG) fuel line (FIG. 3e, page 16) feeding the aux engine is plumbed through the base stand of the wind turbine and connected to the aux engine via a swivel connector.

### BRIEF DESCRIPTION OF THE SEVERAL VIEWS OF THE DRAWING:

FIG. #1aj, page 14) depicts a cross section of the entire device, showing the propeller on the front of the wind turbine and the aux engine mounted on the rear of the unit.

FIG. #2a-b, page 15) illustrates the viscous clutch and that connects the aux engine to main power generation shaft and other engine details, such as the flywheel, fuel connection and engine mounts.

FIG. #3a-d, page 16) shows the auto-start/stop sensors and switches mounted on the engine to control when it engages to augment the wind powered generator.

### DETAILED DESCRIPTION OF THE INVENTION

A 100-250 horsepower, aluminum and cast iron natural gas (CNG) powered engine equipped with auto start/stop switching (FIG. 3a-d, page 16) mounted on the rear of the wind-power generation unit (under the unit weather fairing) that is coupled to the main turbine shaft of the wind powered electrical generator. The engine is connected to the main power generator throughput shaft via a planetary drive/viscous coupling (FIG. 2a, page 15) or clutch (borrowed from full-time all wheel drive vehicles) that allows power to be applied to the main generator shaft as needed and also to freewheel without placing drag or resistance on the main shaft when the aux engine isn't needed. A natural gas fuel line (FIG. 3e, page 16) feeding the aux engine is plumbed through the base stand of the wind turbine and connected to the aux engine.

### Other Design Features:

Performance

Compressed Natural Gas (CNG) Fuel

High torque

Low emissions, meeting CARB/EPA standards or better

Licensed Proprietary Controller (From Industrial Controller Supplier)

Programmable electronic feature including cruise control, max RPM speed, PTO, engine protection, and diagnostic capability

Fuel and System (State-of-the-Art Industrial/Automotive, e.g.)

Electronically controlled gaseous delivery Management system

Fuel economy comparable to diesel engines of similar output

Extended maintenance intervals

Lean burn, Closed Loop Adaptive Learn Technology

Electronically controlled wastegate turbocharger

CARB/EPA emission certified for use in 50 states

CARB optional low 1.2 g/bhp-hr NOx+NMHC for MHHD, HHDD

Adding a CNG fueled, auxiliary power source to large, wind powered electrical generators is unique and necessary to reduce our national energy dependence upon dirty sources of electrical power (coal fired power plants, for example). The CNG powered auxiliary engine/wind generator can be more widely deployed nationally (outside of constant high-wind areas), while generating clean electricity using America's abundant supply of natural gas to augment wind power when it is needed.

1. Uses an aircraft style suspension mount (FIG. 3, engine mount plate, page 16) to hang the engine off the rear of the wind generator assembly and also correctly align the engine with the main power shaft;

2. Uses an automotive or industrial “on-demand” auto-start/cut-off switch (FIG. 3a, page 16), permitting the engine to instantaneously engage when needed and also rapidly cut-off as wind conditions warrant;

3. Employs a shaft speed sensing switch (FIG. 3b, page 16), triggering the auto-start mechanism and engaging the engine to maintain adequate main shaft RPM when wind velocity isn't adequate to turn the generator;

4. Uses a planetary drive or other viscous clutch (FIG. 3, viscous coupling/gear box, page 16) allowing the engine power supply shaft to freewheel without creating shaft drag when not needed;

5. CNG engine is rated at between 100-250 shaft horsepower, depending upon size of the wind generator and region of the country where deployed.
